(19) United States
(12) Patent Application Publication
(10) Pub. No.: US 2022/0375688 A1
(43) Pub. Date: Nov. 24, 2022

(54) MULTILAYER ELECTRONIC COMPONENT AND DIELECTRIC COMPOSITION

(71) Applicant: SAMSUNG ELECTRO-MECHANICS CO., LTD., Suwon-si (KR)

(72) Inventors: Seok Hyun YOON, Suwon-si (KR); Jin Woo KIM, Suwon-si (KR); In Ho JEON, Suwon-si (KR); Joo Hee LEE, Suwon-si (KR)

(73) Assignee: SAMSUNG ELECTRO-MECHANICS CO., LTD., Suwon-si (KR)

(21) Appl. No.: 17/523,212

(22) Filed: Nov. 10, 2021

(30) Foreign Application Priority Data
May 18, 2021 (KR) 10-2021-0064090

(51) Int. Cl. H01G 4/12; H01G 4/30; C04B 35/468

(52) U.S. Cl. CPC H01G 4/1227; H01G 4/30; C04B 35/4682; C04B 2235/3236; C04B 2235/3267; C04B 2235/3239; C04B 2235/3224; C04B 2235/3418; C04B 2235/442; C04B 2235/40; C04B 2235/404; C04B 2235/85

(57) ABSTRACT

A multilayer electronic component includes a body including a dielectric layer and an internal electrode; and an external electrode disposed on the body and connected to the internal electrode, wherein the dielectric layer includes first and second grains, wherein the first grain has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second grain has an atomic ratio of 2*Sn/(Ba+Ti+Sn) and 2*Hf/(Ba+Ti+Hf) to be less than 1.0%, and wherein an area occupied by the first grain in an entire area of the first and second grains is 28.3-82.3%.

### CROSS-REFERENCE TO RELATED APPLICATION(S)

This application claims the benefit of priority to Korean Patent Application No. 10-2021-0064090 filed on May 18, 2021 in the Korean Intellectual Property Office, the disclosure of which is incorporated herein by reference in its entirety.

### TECHNICAL FIELD

The present disclosure relates to a multilayer electronic component and a dielectric composition.

### BACKGROUND

A multilayer ceramic capacitor (MLCC), a multilayer electronic component, may be a chip-type condenser mounted on various electronic products such as an imaging device including a liquid crystal display (LCD) and a plasma display panel (PDP), a computer, a smartphone, and a mobile phone, and may charge or discharge electricity.

Such a multilayer ceramic capacitor may be used as a component of various electronic devices through having a small size, guarantee of high capacity, and being easily mounted. Recently, as various electronic devices such as computers and mobile devices have been miniaturized and have high output, demand for miniaturization and high capacity in a multilayer ceramic capacitor has also increased.

To obtain miniaturization and high capacity of a multilayer ceramic capacitor, it may be necessary to increase the number of laminated layers by decreasing a thickness of a dielectric layer and an internal electrode. A thickness of a dielectric layer has reached the level of about 0.6 μm, and the reduction of the thickness has been continued.

However, as a thickness of a dielectric layer decreases, reliability and high-temperature withstand voltage properties and also DC-bias properties may be problematic. The DC-bias properties may refer to a phenomenon in which capacitance or a dielectric constant may decrease as a magnitude of a DC-bias field applied to an MLCC increases. In various applications of an MLCC as in a power management integrated circuit, an MLCC may be used while a DC-bias is applied, and accordingly, there has been increasing demand for an MLCC implementing a high effective dielectric constant or capacitance under a condition in which a high electric field DC-bias is applied, and a dielectric composition for manufacturing the same.

### SUMMARY

An aspect of the present disclosure is to provide a multilayer electronic component having improved reliability and a dielectric composition.

Another aspect of the present disclosure is to provide a multilayer electronic component having an improved room-temperature dielectric constant, improved DC-bias properties, and improved high-temperature withstand voltage properties, and a dielectric composition.

Another aspect of the present disclosure is to provide a multilayer electronic component which may satisfy X7R or X7S capacitance and temperature properties and a dielectric composition.

According to an aspect of the present disclosure, a multilayer electronic component includes a body including a dielectric layer and an internal electrode; and an external electrode disposed on the body and connected to the internal electrode, wherein the dielectric layer includes first and second grains, wherein the first grain has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second grain has an atomic ratio of 2*Sn/(Ba+Ti+Sn) and 2*Hf/(Ba+Ti+Hf) to be less than 1.0%, and wherein an area occupied by the first grain in an entire area of the first and second grains is 28.3-82.3%.

According to another aspect of the present disclosure, a multilayer electronic component includes a main component including first and second main components based on BaTiO₃, wherein the first main component has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second main component has anatomic ratio of 2*Sn/(Ba+Ti+Sn) and 2*Hf/(Ba+Ti+Hf) to be less than 1.0%, and wherein, when a molar ratio of the first main component is defined as x and a molar ratio of the second main component is defined as 1-x, x is 0.3-0.8.

According to another aspect of the present disclosure, a multilayer electronic component includes a dielectric layer including first and second grains. The first grain has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second grain has an atomic ratio of 2*Sn/(Ba+Ti+Sn) and 2*Hf/(Ba+Ti+Hf) to be less than 1.0%. A size of the core of the first grain is 50 nm or more and 250 nm or less.

According to another aspect of the present disclosure, a multilayer electronic component includes a dielectric composition including a main component, the main component including first and second main components based on BaTiO_{3.} The first main component has a core-shell structure including a shell having an atomic ratio of 2*Sn/(Ba+Ti+Sn) or 2*Hf/(Ba+Ti+Hf) to be 1.00 or more and 5.00 or less, and a core having an atomic ratio of 2*Sn/(Ba+Ti+Sn) and 2*Hf/(Ba+Ti+Hf) to be less than 1 .0%, and the second main component has an atomic ratio of 2*Sn/(Ba+Ti+Sn) and 2*Hf/(Ba+Ti+Hf) to be less than 1 .0%. A size of the core of the first main component is 40-200 nm.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a multilayer electronic component according to an example embodiment of the present disclosure;

FIG. 2 is a cross-sectional diagram illustrating a multilayer electronic component in FIG. 1 taken along line I-I′;

FIG. 3 is a cross-sectional diagram illustrating a multilayer electronic component in FIG. 1 taken along line II-II′;

FIG. 4 is an exploded perspective diagram illustrating a body of a multilayer electronic component according to an example embodiment of the present disclosure;

FIG. 5 is a diagram illustrating a microstructure of a dielectric layer according to an example embodiment of the present disclosure;

FIG. 6 is an image indicating positions P1-P9 in which a content of Sn or Hf is analyzed in a first grain and a second grain by STEM/EDS analysis;

FIG. 7 is a graph illustrating a content of Sn in P1-P9 of a first grain;

FIG. 8 is a graph illustrating a content of Sn in P1-P9 of a second grain; and

FIG. 9 is a cross-sectional diagram illustrating a first main component.

### DETAILED DESCRIPTION

In the description below, embodiments of the present disclosure will be described as follows with reference to the attached drawings.

The present disclosure may, however, be exemplified in many different forms and should not be construed as being limited to the specific embodiments set forth herein. Rather, these embodiments are provided such that this disclosure will be thorough and complete, and will fully convey the scope of the disclosure to those skilled in the art. Accordingly, shapes and sizes of elements in the drawings may be exaggerated for clarity of description, and elements indicated by the same reference numeral are the same elements in the drawings.

In the drawings, same elements will be indicated by same reference numerals. Also, redundant descriptions and detailed descriptions of known functions and elements that may unnecessarily make the gist of the present invention obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” etc. of the description are used to indicate the presence of features, numbers, steps, operations, elements, parts or combination thereof, and do not exclude the possibilities of combination or addition of one or more features, numbers, steps, operations, elements, parts or combination thereof.

In the drawings, the first direction may be defined as a lamination direction or a thickness (T) direction, the second direction may be defined as a length (L) direction, and the third direction may be defined as a width (W) direction.

Multilayer Electronic Component

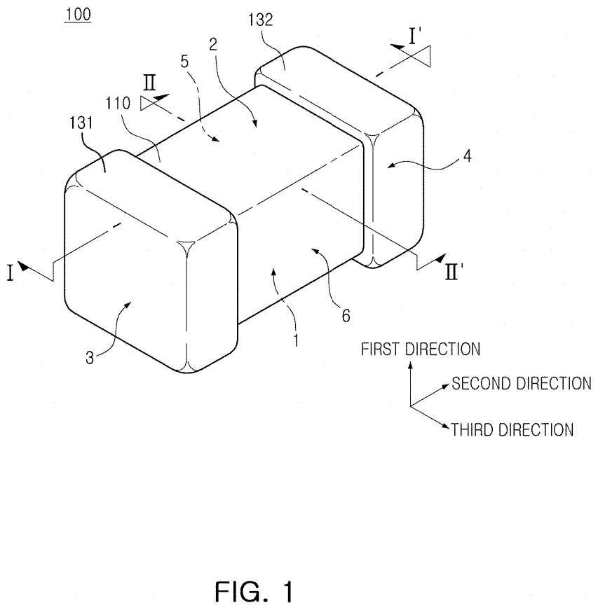

FIG. 1 is a perspective diagram illustrating a multilayer electronic component according to an example embodiment.

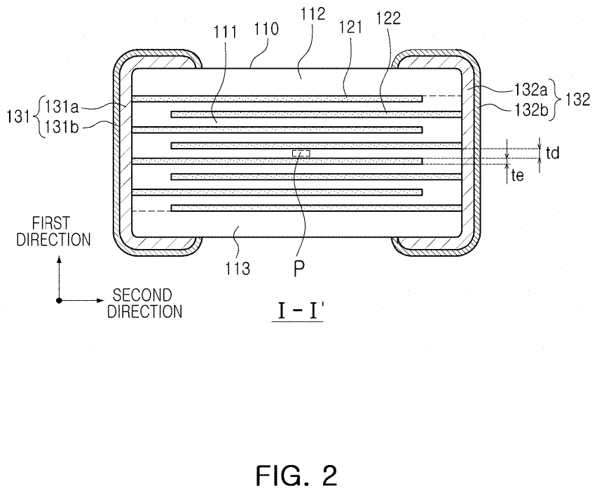

FIG. 2 is a cross-sectional diagram illustrating a multilayer electronic component in FIG. 1 taken along line I-I′.

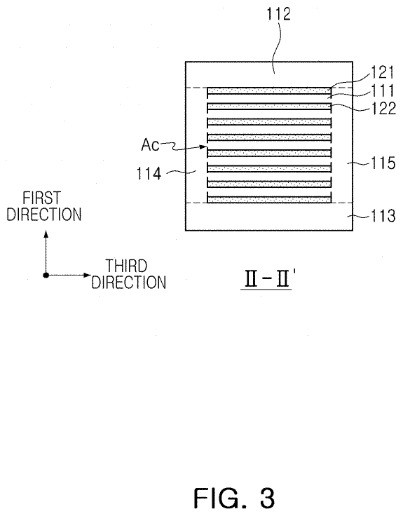

FIG. 3 is a cross-sectional diagram illustrating a multilayer electronic component in FIG. 1 taken along line

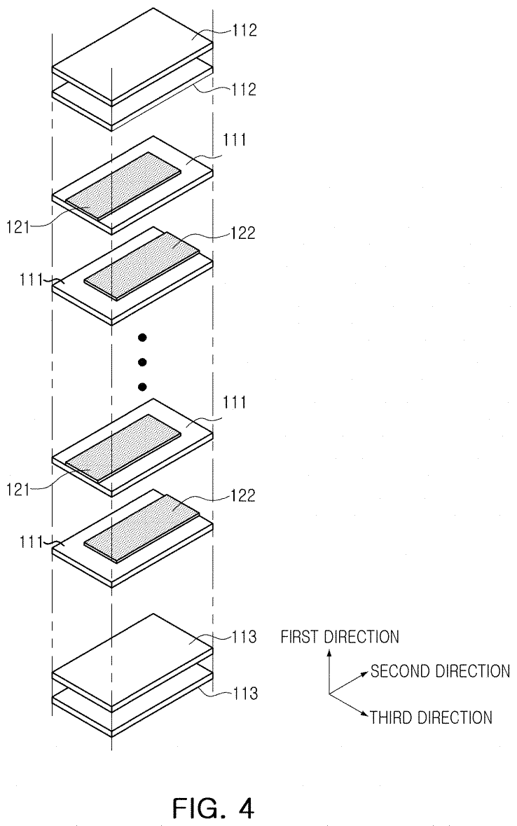

FIG. 4 is an exploded perspective diagram illustrating a body of a multilayer electronic component according to an example embodiment.

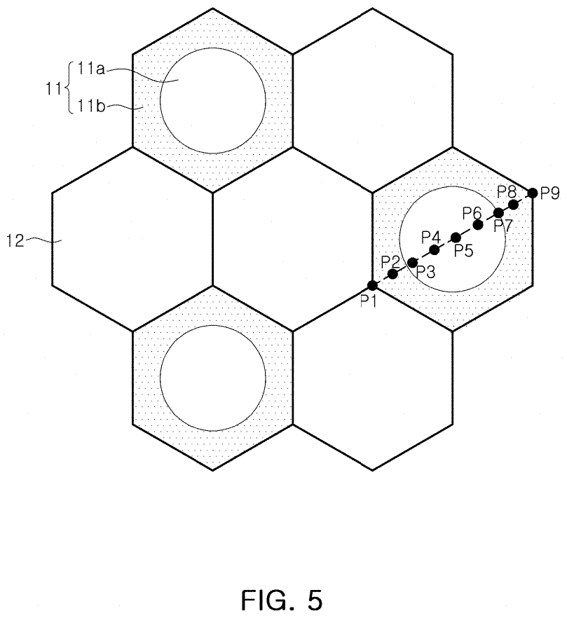

FIG. 5 is a diagram illustrating a microstructure of a dielectric layer according to an example embodiment.

Hereinafter, a multilayer electronic component according to an example embodiment will be described in greater detail with reference to FIGS. 1 to 5. However, a multilayer ceramic capacitor will be described as an example of a multilayer electronic component, but the example embodiment may be applied to various electronic products using a dielectric composition, such as, for example, an inductor, a piezoelectric element, a varistor, or a thermistor.

A multilayer electronic component 100 in an example embodiment may include a body 110 including a dielectric layer 111 and internal electrodes 121 and 122; and external electrodes 131 and 132 disposed on the body and connected to the internal electrodes. The dielectric layer 111 may include first and second grains 11 and 12, and the first grain 11 may have a core-shell structure including a shell 11b having an atomic ratio of 2*Sn/(Ba+Ti+Sn) or 2*Hf/(Ba+Ti+Hf) to be 1.0% or more and 5.0% or less, and a core 11a having an atomic ratio of 2*Sn/(Ba+Ti+Sn) and 2*Hf/(Ba+Ti+Hf) to be less than 1.0%, and the second grain 12 may have an atomic ratio of 2*Sn/(Ba+Ti+Sn) and 2*Hf/(Ba+Ti+Hf) to be less than 1.0%, and an area occupied by the first grain in an entire area of the first and second grains may be 28.3-82.3%.

The body 110 may include a dielectric layer 111 and internal electrodes 121 and 122 alternately laminated.

The shape of the body 110 may not be limited to any particular shape, but as illustrated, the body 110 may have a hexahedral shape or a shape similar to a hexahedral shape. Due to reduction of ceramic powder included in the body 110 during a baking process, the body 110 may not have an exact hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

The plurality of dielectric layers 111 forming the body 110 maybe in a baked state, and a boundary between the adjacent dielectric layers 111 may be integrated with each other such that the boundary may not be distinct without using a scanning electron microscope (SEM).

The body 110 may include a capacitance forming portion Ac disposed in the body 110 and forming capacitance including the first internal electrode 121 and the second internal electrode 122 disposed to oppose each other with the dielectric layer 111 interposed therebetween, and cover portions 112 and 113 formed above and below the capacitance forming portion Ac in the first direction.

Also, the capacitance forming portion Ac may contribute to capacitance formation of the capacitor, and may be formed by repeatedly laminating a plurality of first and second internal electrodes 121 and 122 with a dielectric layer 111 interposed therebetween.

The dielectric layer 111 may include first and second grains 11 and 12, and the first grain 11 may have a core-shell structure including the shell 11b having an atomic ratio of 2*Sn/(Ba+Ti+Sn) or 2*Hf/(Ba+Ti+Hf) to be 1.0% or more and 5.0% or less, and the core 11a having an atomic ratio of 2*Sn/(Ba+Ti+Sn) and 2*Hf/(Ba+Ti+Hf) to be less than 1.0%, and the second grain 12 may have an atomic ratio of 2*Sn/(Ba+Ti+Sn) and 2*Hf/(Ba+Ti+Hf) to be less than 1.0%, and an area occupied by the first grain in an entire area of the first and second grains may be 28.3-82.3%. Accordingly, a room temperature dielectric constant may satisfy 2500 or more, a DC-bias dielectric constant at 7 V/μm may satisfy 1050 or more, a withstand voltage at 150° C. may satisfy 65 V/μm or more, an RC value may satisfy 1000 ΩF or more, and TCC at 55° C. and 125° C. may satisfy −22% to 22%, which may be target properties in the example embodiment.

In a system to which BaTiO₃, a main component of a dielectric, is applied, the dielectric properties may change greatly depending on an A/B site ratio in an ABO₃ structure in which an additive is solid-solute, such that the dielectric properties may be adjusted by adjusting the A/B ratio by adjusting a content of the Ba/Si subcomponent. Generally, when the A/B ratio is increased by increasing the Ba content, which is an additive subcomponent, the DC-bias properties may improve as a nominal dielectric constant decreases. However, in this case, sintering temperature may increase and the density of the sintered body may be lowered, such that reliability may be deteriorated, and the room temperature dielectric constant may excessively decrease, and accordingly, it may be difficult to implement nominal capacitance.

In an example embodiment, by securing the first gain 11 having a core-shell structure including the shell 11b having an atomic ratio of 2*Sn/(Ba+Ti+Sn) or 2*Hf/(Ba+Ti+Hf) to be 1.00 or more and 5.0% or less, and the core 11a having anatomic ratio of 2*Sn/(Ba+Ti+Sn) and 2*Hf/(Ba+Ti+Hf) to be less than 1.0%, the density of the sintered body may be good, and a suitable room-temperature dielectric constant, excellent DC-bias properties, and high reliability may be secured at the same time.

When the value of 2*Sn/(Ba+Ti+Sn) or 2*Hf/(Ba+Ti+Hf) of the shell lib is less than 1.0%, it may be difficult to secure the dielectric constant of 1050 or more at DC 7 V/μm, it may be difficult to secure a high-temperature withstand voltage of 65 V/μm or higher at 150° C., and it may be difficult to secure a room-temperature dielectric constant of 2500 or higher.

When the value of 2*Sn/(Ba+Ti+Sn) or 2*Hf/(Ba+Ti+Hf) of the shell 11b is greater than 5.0%, Sn or Hf may segregate and may form a secondary phase, such that uniformity may degrade, and accordingly, it may be difficult to implement the target properties in the example embodiment.

Also, when the area of the first grains is less than 28.3%, it may be difficult to secure the dielectric constant of 1050 or more at DC 7 V/μm, and when the area exceeds 82.3%, it may be difficult to secure the room temperature dielectric constant of 2500 or more.

As illustrated in FIG. 5, as for the Sn or Hf content of the first grain, a line starting from the left side of a grain boundary and ending at the right side of the grain boundary may be drawn in the grain boundary and 9 points P1-P9 may be taken with an equivalent interval, and the content of Sn or Hf in P1-P9 may be analyzed using STEM/EDS.

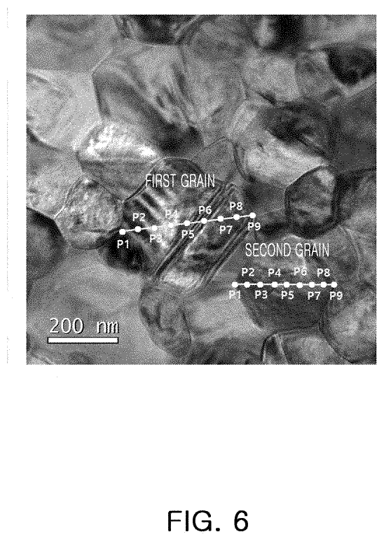

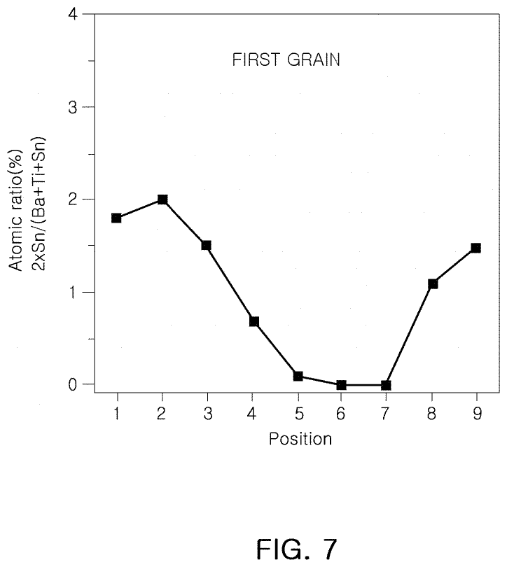

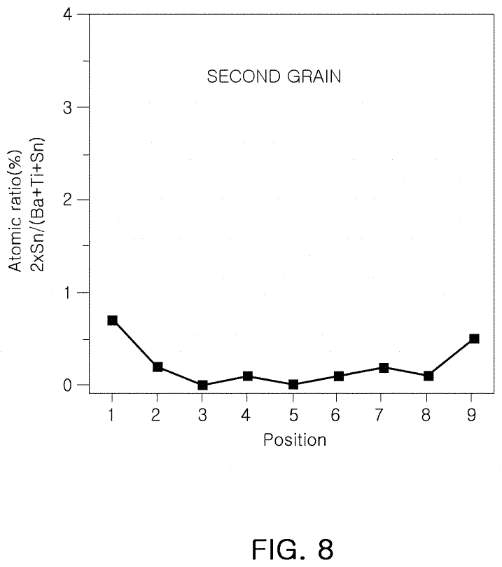

More specifically, after obtaining an image by scanning with an STEM as in FIG. 6 for the P region in FIG. 2, the content of Sn or Hf in positions P1-P9 may be analyzed by STEM/EDS analysis. As illustrated in FIG. 7, a grain having both a point in which the atomic ratio of 2*Sn/(Ba+Ti+Sn) is 1.0% or more and 5.0% or less and a point in which the atomic ratio is less than 1.0% in the points P2-P8 other than the grain boundary may be defined as the first grain. As illustrated in FIG. 8, a grain in which the atomic ratio of 2*Sn/(Ba+Ti+Sn) in the points P2-P8 is less than 1.0% may be defined as the second grain.

Sn or Hf may be solid-solute in BaTiO_{3.} For example, when 10 mol of Sn is solid-solute based on 100 mol of BaTiO₃, Ba(Tio.9Sno.1)03 may be obtained. In this case, the value of 2*Sn/(Ba+Ti+Sn) may be 0.1 or 10%.

Also, the first grain and the second grain may be distinguished from each other by measuring the Sn or Hf content of 30 adjacent grains, and the area ratio of the first grain may be obtained by calculating each area.

Also, the core size of the first grain may be a measurement of the size of the area in which 2*Sn/(Ba+Ti+Sn) is all less than 1.0% in FIG. 7, and may be an average value of the sizes of cores classified as the first grains.

In an example embodiment, Sn or Hf in the first grains 11 and the second grains 12 may be solid-solute in BaTiO₃.

Furthermore, other subcomponent elements may be solid-solute in the first grain 11 and the second grain 12.

In an example embodiment, the size of the core 11a of the first grain 11 may be 50 nm or greater and 250 nm or less.

When the size of the core 11a is less than 50 nm, the room temperature dielectric constant may be lowered, and the TCC at −55° C. and 125° C. may be beyond the range of ±22%.

When the size of the core 11a exceeds 250 nm, the DC-bias properties and high-temperature withstand voltage properties may be deteriorated.

In an example embodiment, the thickness (or size) of the shell 11b of the first grain 11 may not be limited to any particular size, but may be 10-250 nm. The thickness (or size) of the shell 11b may refer to a distance from the surface of the core to the surface of the shell.

The dielectric layer 111 may include a dielectric composition according to an example embodiment. Also, the dielectric layer 111 may be formed by sintering a dielectric composition according to an example embodiment.

A subcomponent included in the dielectric composition may be added in the form of oxide or carbonate, but after sintering, the subcomponent may be solid-solute in BaTiO₃ rather than present in the form of oxide or carbonate. However, the content ratio of the main components of the subcomponent may be maintained almost the same, and the content of each element of the dielectric layer after sintering may be calculated based on the contents of the main component and subcomponents included in the dielectric composition before sintering.

Also, the content of each element included in the dielectric layer 111 may be measured using a non-destructive method, a destructive method, or the like.

For example, as for a non-destructive method, a component in a dielectric grain may be analyzed in the central portion of a chip using TEM-EDS. Specifically, an analysis sample having a reduce thickness may be prepared by using a focused ion beam (FIB) device in a region including a dielectric layer in one cross-sectional surface of the sintered body. The damaged layer on the surface of the sample may be removed using Ar ion milling, and mapping and quantitative analysis of each component may be carried out on the image obtained using

STEM-EDS. In this case, the quantitative analysis graph of each component may be obtained as the mass fraction of each element, which may be represented by converting the fraction into a mole fraction or an atomic fraction.

Also, as for the destructive method, the multilayer electronic component may be crushed, the internal electrode may be removed, and the dielectric portion may be selected, and the composition of the selected dielectric may be analyzed using an inductively coupled plasma spectroscopy (ICP-OES), and an inductively coupled plasma mass spectrometer (ICP).

The cover portions 112 and 113 may include an upper cover portion 112 disposed above the capacitance forming portion Ac in the first direction and a lower cover portion 113 disposed below the capacitance forming portion Ac in the first direction.

The upper cover portion 112 and the lower cover portion 113 may be formed by laminating a single dielectric layer or two or more dielectric layers on the upper and lower surfaces of the capacitance forming portion Ac in the thickness direction, respectively, and may prevent damages to the internal electrode caused by physical and chemical stress.

The upper cover portion 112 and the lower cover portion 113 may not include an internal electrode, and may include the same material as that of the dielectric layer 111.

In other words, the upper cover portion 112 and the lower cover portion 113 may include a ceramic material, such as a barium titanate (BaTiO₃) ceramic material, for example.

The thickness of the cover portion 112 and 113 may not limited to any particular size. However, to easily obtain miniaturization and high capacity of the multilayer electronic component, the thickness of the cover portions 112 and 113 may be 20 μm or less.

Also, margin portions 114 and 115 may be disposed on a side surface of the capacitance forming portion Ac.

The margin portions 114 and 115 may include a margin portion 114 disposed on the fifth surface 5 of the body 110 and a margin portion 115 disposed on the sixth surface 6 of the body 110. In other words, the margin portions 114 and 115 may be disposed on both side surfaces of the ceramic body 110 in the width direction.

As illustrated in FIG. 3, the margin portions 114 and 115 may refer to a region between ends of the first and second internal electrodes 121 and 122 and the boundary surface of the body 110 in the cross-sectional surface of the body 110 in the width-thickness (WT) direction.

The margins 114 and 115 may prevent damage to the internal electrodes caused by physical or chemical stress.

The margin portions 114 and 115 may be formed by forming internal electrodes by applying a conductive paste on the ceramic green sheet other than the region in which the margin portion is formed.

Also, to present a step difference due to the internal electrodes 121 and 122, after lamination, the internal electrodes may be cut to be exposed to the fifth and sixth surfaces 5 and 6 of the body, a single dielectric layer or two or more dielectric layers maybe laminated on both side surfaces of the capacitance forming portion Ac in the width direction (third direction), thereby forming the margin portions 114 and 115.

In an example embodiment, in a cross-sectional surface taken in the first and third directions from the center of the body in the second direction, the region Aa may be a region of the capacitance forming portion including five dielectric layers arranged with reference to a point ½ in the first direction, and the region Ab may be a region of the capacitance forming portion including five dielectric layers adjacent to the cover portion.

More specifically, with reference to FIG. 5, in a cross-sectional surface taken in the first and third directions from the center of the body 110 in the second direction, the region Aa of the capacitance forming portion Ac including five dielectric layers arranged with reference to the ½ point in the first direction and the region Ab of the capacitance forming portion including five dielectric layers adjacent to the cover portion may be scanned using a scanning electron microscope (SEM), and the size of each dielectric grain may be measured from the scanned image. In this case, the size of the dielectric grains may be determined by measuring the area of each dielectric grain, and a value converted into a diameter equivalent to a circle having the area may be determined as the size of the dielectric grain.

In an example embodiment, the average size of the plurality of dielectric grains included in the region Aa may be 300 nm or less, the average size of the plurality of dielectric grains included in the region Ab may be 130 nm or more, and a difference between the average size of the plurality of dielectric grains included in the region Aa and the average size of the plurality of dielectric grains included in the region Ab may be 100 nm or less.

The thickness td of the dielectric layer 111 may not be limited to any particular size.

However, when the dielectric layer generally has a thickness of less than 0.6 μm, in particular, when the thickness of the dielectric layer is 0.45 μm or less, reliability may degrade.

As described above, in an example embodiment, excellent room-temperature dielectric constant, DC-bias properties, and high-temperature withstand voltage properties may be obtained, excellent reliability may be obtained even when the thickness of the dielectric layer 111 is 0.45 μm or less.

Accordingly, when the thickness of the dielectric layer 111 is 0.45 μm or less, the reliability improvement effect in an example embodiment may be more prominent.

The thickness td of the dielectric layer 111 may refer to an average thickness of the dielectric layer 111 disposed between the first and second internal electrodes 121 and 122.

The average thickness of the dielectric layer 111 may be measured by scanning an image of the cross-sectional surface of the body 110 in the length and thickness direction (L-T) using a scanning electron microscope (SEM).

For example, the thicknesses of 30 points with an equivalent interval in the length direction of a dielectric layer from an image obtained by scanning a cross-sectional surface taken in the first and second directions (length and thickness direction) of a central portion of the body 110 in the third direction (width direction) may be measured, and an average thereof may be measured.

The thickness measured at the 30 points with an equivalent interval may be measured in a capacitance forming portion Ac, a region in which the first and second internal electrodes 121 and 122 overlap each other.

The internal electrodes 121 and 122 may be alternately laminated with the dielectric layer 111.

The internal electrodes 121 and 122 may include first and second internal electrodes 121 and 122. The first and second internal electrodes 121 and 122 may be alternately disposed to oppose each other with the dielectric layer 111 forming the body 110 interposed therebetween, and may be exposed to the third and fourth surfaces 3 and 4 of the body 110, respectively.

Referring to FIG. 2, the first internal electrode 121 maybe spaced apart from the fourth surface 4 and may be exposed through the third surface 3, and the second internal electrode 122 may be spaced apart from the third surface 3 and may be exposed through the fourth surface 4.

In this case, the first and second internal electrodes 121 and 122 may be electrically separated from each other by the dielectric layer 111 disposed therebetween.

Referring to FIG. 4, the body 110 may be formed by alternately laminating a ceramic green sheet on which the first internal electrode 121 is printed and a ceramic green sheet on which the second internal electrode 122 is printed, and baking the sheets.

A material for forming the internal electrodes 121 and 122 is not limited to any particular material, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), or alloys thereof.

Also, the internal electrodes 121 and 122 may be formed by printing a conductive paste for internal electrode including one or more of nickel (Ni), copper (Cu), palladium (Pd), silver (Ag), gold (Au), platinum (Pt), tin (Sn), tungsten (W), titanium (Ti), or alloys thereof. As the method for printing the conductive paste for internal electrodes, a screen printing method or a gravure printing method may be used, but an example embodiment thereof is not limited thereto.

The thickness to of the internal electrodes 121 and 122 may not limited to any particular size.

However, generally, when the internal electrode has a thickness of less than 0. 6 μm, in particular, when the thickness of the internal electrode is 0.45 μm or less, reliability may degrade.

As described above, in an example embodiment, an excellent room-temperature dielectric constant, DC-bias properties, high-temperature withstand voltage properties may be secured, such that, when the thickness of the internal electrodes 121 and 122 is 0.45 μm or less, excellent reliability may be secured.

Accordingly, when the thickness of the internal electrodes 121 and 122 is 0.45 μm or less, the effect in an example embodiment may be more prominent, and miniaturization and high capacity of the multilayer electronic component may be easily obtained.

The thickness to of the internal electrodes 121 and 122 may refer to an average thickness of the internal electrodes 121 and 122.

The average thickness of the internal electrodes 121 and 122 may be measured by scanning a cross-sectional surface of the body 110 taken in the length and thickness direction (L-T) using a scanning electron microscope (SEM).

For example, the thicknesses of 30 points with an equivalent interval in the length direction of the first and second internal electrodes 121 and 122 from an image obtained by scanning a cross-sectional surface taken in the first and second directions (length and thickness direction) of a central portion of the body 110 in the third direction (width direction) may be measured, and an average thereof may be measured.

The 30 points with an equivalent interval may be measured in the capacitance forming portion Ac, a region in which the first and second internal electrodes 121 and 122 overlap each other.

The external electrodes 131 and 132 may be disposed on the third surface 3 and the fourth surface 4 of the body 110.

The external electrodes 131 and 132 may include first and second external electrodes 131 and 132 disposed on the third and fourth surfaces 3 and 4 of the body 110, respectively, and connected to the first and second internal electrodes 121 and 122, respectively.

Referring to FIG. 1, the external electrodes 131 and 132 may be disposed to cover both end surfaces of side margin portions 114 and 115 in the second direction.

In the example embodiment, the ceramic electronic component 100 may have two external electrodes 131 and 132, but the number and shape of the external electrodes 131 and 132 may be varied depending on the form of the internal electrodes 121 and 122 or for other purposes.

The external electrodes 131 and 132 may be formed using any material having electrical conductivity, such as metal, and a specific material may be determined in consideration of electrical properties, structural stability, or the like, and the external electrodes 131 and 132 may have a multilayer structure.

For example, the external electrodes 131 and 132 may include electrode layers 131a and 132a disposed on the body 110 and plating layers 131b and 132b formed on the electrode layers 131a and 132a.

For example, the electrode layers 131a and 132a may be a baked electrode including a conductive metal and glass, or a resin-based electrode including a conductive metal and a resin.

Also, the electrode layers 131a and 132a may have a shape in which a baked electrode and a resin-based electrode are formed in order on a body. Also, the electrode layers 131a and 132a may be formed by transferring a sheet including a conductive metal onto the body or by transferring a sheet including a conductive metal onto the baked electrode.

As the conductive metal included in the electrode layers 131a and 132a, a material having excellent electrical conductivity may be used, and the material is not limited to any particular material. For example, the conductive metal may be one or more of nickel (Ni), copper (Cu), and alloys thereof.

The plating layers 131b and 132b may improve mounting properties. The type of the plating layers 131b and 132b is not limited to any particular type, and the plating layers 131b and 132b may be a plating layer including one or more of Ni, Sn, Pd, and alloys thereof, and may include a plurality of layers.

For example, the plating layers 131b and 132b may be a Ni plating layer or a Sn plating layer, and a Ni plating layer and a Sn plating layer may be formed in order on the electrode layers 131a and 132a, or a Sn plating layer, a Ni plating layer, and a Sn plating layer may be formed in order. Also, the plating layers 131b and 132b may include a plurality of Ni plating layers and/or a plurality of Sn plating layers.

The size of the ceramic electronic component 100 may not limited to any particular size.

However, to obtain miniaturization and high capacitance at the same time, the number of laminates may need to be increased by reducing the thickness of the dielectric layer and the internal electrode. Thus, the effect of improving DC-bias properties and high temperature withstand voltage properties in the example embodiment may be prominent in the ceramic electronic component 100 having a size of 0402 (length×width, 0.4 mm×0.2 mm) or less.

Accordingly, considering a manufacturing error and the size of the external electrode, when the length of the ceramic electronic component 100 is 0.44 mm or less and the width is 0.22 mm or less, the reliability improvement effect in the example embodiment may be prominent. The length of the ceramic electronic component 100 may refer to a maximum size of the ceramic electronic component 100 in the second direction, and the width of the ceramic electronic component 100 may refer to a maximum size of the ceramic electronic component 100 in the third direction.

Dielectric Composition

A dielectric composition in an example embodiment may include a main component including first and second main components based on BaTiO₃, and the first main component 13 may include a shell 13b having an atomic ratio of 2*Sn/(Ba+Ti+Sn) or 2*Hf/(Ba+Ti+Hf) to be 1.0% or more and 5.0% or less, and a core 13a having an atomic ratio of 2*Sn/(Ba+Ti+Sn) and 2*Hf/(Ba+Ti+Hf) to be less than 1.0%, and the second main component may have an atomic ratio of 2*Sn/(Ba+Ti+Sn) and 2*Hf/(Ba+Ti+Hf) to be less than 1.0%, and when a molar ratio of the first main component 13 is defined as x and a molar ratio of the second main component is defined as 1-x, x may be 0.3-0.8.

The dielectric composition may form a dielectric layer 111 after sintering, and the dielectric layer 111 may include first and second grains 11 and 12. The first grain 11 may have a core-shell structure including a shell 11b having an atomic ratio of 2*Sn/(Ba+Ti+Sn) or 2*Hf/(Ba+Ti+Hf) to be 1.0% or more and 5.0% or less, and a core 11a having an atomic ratio of 2*Sn/(Ba+Ti+Sn) and 2*Hf/(Ba+Ti+Hf) to be less than 1.0%, and the second grain may have an atomic ratio of 2*Sn/(Ba+Ti+Sn) and 2*Hf/(Ba+Ti+Hf) to be less than 1.0%, and an area occupied by the first grain in an entire area of the first and second grains may be 28.3-82.3%. Accordingly, a room temperature dielectric constant may satisfy 2500 or more, a DC-bias dielectric constant at 7 V/μm may satisfy 1050 or more, a withstand voltage at 150° C. may satisfy 65 V/μm or more, an RC value may satisfy 1000 ΩF or more, and TCC at 55° C. and 125° C. may satisfy -22% to 22%, which may be target properties in the example embodiment.

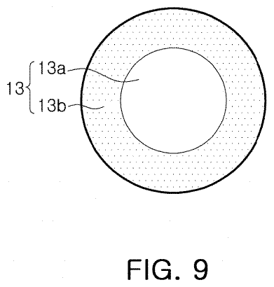

In an example embodiment, the size of the core 13a of the first main component 13 may be 40-200 nm. Referring to FIG. 9 illustrating a cross-sectional diagram of the first main component 13, the size of the core 13a may refer to the diameter of the core 13a.

When the size of the core 13a of the first main component 13 is less than 40 nm, it may be difficult to secure the size of the core 11a of the first grain 11 formed after sintering to be 50 nm or more, such that the room temperature dielectric constant may be lowered, and the TCC at −55° C. and 125° C. may be beyond the range of ±22%.

When the size of the core 13a of the first main component 13 exceeds 200 nm, it may be difficult to secure the size of the core 11a of the first grains 11 formed after sintering to be 250 nm or less, such that DC-bias properties and high-temperature withstand voltage properties may be deteriorated.

Also, the first main component 13 and the second main component may be in the form of powder.

The method for producing the first main component 13 may not be limited to any particular method, and, for example, a hydrothermal synthesis method may be used. Specifically, when BaTiO₃ particles are formed during the hydrothermal synthesis process and Sn or Hf element is added during the grain growth process, the core 13a in a central portion of the powder may be pure BaTiO₃ and the shell 13b on an edge of the powder may be core-shell powder in which Sn or Hf is solid-solute, and the size of the core area and the size of the powder may be adjusted. The second main component may be prepared by a solid-phase method or a hydrothermal synthesis method.

Hereinafter, the sub-components included in the dielectric composition in an example embodiment will be described in greater detail.

a) First subcomponent

In an example embodiment, the dielectric composition may further include a first subcomponent including one or more of an oxide or a carbonate of a variable valence acceptor element, wherein the variable valence acceptor element may include one or more of Mn, V, Cr, Fe, Ni, Co, Cu, and Zn, and the content of the variable valence acceptor element included in the first subcomponent may be 0.2 mol to 1.4 mol based on 100 mol of the main component.

The variable valence acceptor element included in the first subcomponent may decrease the baking temperature of the multilayer ceramic capacitor to which the dielectric composition is applied, and may improve high-temperature withstand voltage properties of the multilayer ceramic capacitor.

When the content of the variable valence acceptor element included in the first subcomponent is less than 0.2 mol, high-temperature withstand voltage properties may degrade, and when the content exceeds 1.4 mol, the RC value may degrade.

The content of the first subcomponent may be based on the content of one or more of Mn, V, Cr, Fe, Ni, Co, Cu, and

Zn included in the first subcomponent without distinguishing addition forms such as oxide or carbonate. When two or more variable valence acceptor elements are included, the content of the first subcomponent may be based on the content of the total elements.

b) Second Subcomponent

In an example embodiment, the dielectric composition may further include a second subcomponent including one or more of an oxide or a carbonate of Mg, and the content of the Mg element included in the second subcomponent may be 2.0 mol or less based on 100 mol of the main component.

Mg of the second subcomponent may increase the RC value. However, when the Mg element content is more than 2.5 mol, high-temperature withstand voltage properties may be deteriorated.

c) Third Subcomponent

In an example embodiment, the dielectric composition may further include a third subcomponent including one or more of an oxide and a carbonate of a rare earth element, and the rare earth element may include one or more of Y, Dy, Ho, Er, Gd, Ce, Nd, Sm, Tb, Tm, La, Gd, and Yb, and the content of the rare earth element included in the third subcomponent may be 0.6 mol to 3.0 mol based on 100 mol of the main component.

The rare earth element included in the third subcomponent may improve high-temperature withstand voltage properties. When the content of the rare earth element is less than 0.6 mol or more than 3.0 mol, high-temperature withstand voltage properties may be deteriorated.

The content of the third subcomponent may be based on one or more of Y, Dy, Ho, Sm, Gd, Er, La, Ce, Tb, Tm, Yb and

Nd included in the third subcomponent without distinguishing the addition form such as oxide or carbonate. When two or more rare earth elements are included, the content of the third subcomponent maybe based on the content of the total elements.

d) Fourth subcomponent

In an example embodiment, the dielectric composition further may include a fourth subcomponent including one or more of oxide and carbonate of one or more of Ba and Ca, and the sum of the content of one or more of Ba and Ca may be 0.19 mol to 4.8 mol based on 100 mol of the main component.

When the sum of the content of one or more of Ba and Ca is less than 0.19 mol, the RC value may decrease, and when the sum of the content exceeds 4.8 mol, the room temperature dielectric constant and high temperature withstand voltage may decrease.

e) Fifth subcomponent

In an example embodiment, the dielectric composition may further include a fifth subcomponent including one or more of an oxide of Si, and a glass including Si, and the content of the Si element included in the fifth subcomponent may be 0.8 mol to 3.0 mol based on 100 mol of the main component.

When the content of the Si element included in the fifth subcomponent is less than 0.8 mol or more than 3.0 mol, the sintering density may be low, such that the room temperature dielectric constant and high temperature withstand voltage may be deteriorated.

Also, when both the fourth component and the fifth component are added, and when the sum of the contents of one or more of Ba and Ca included in the fourth subcomponent is defined as 4s, and the amount of the Si element included in the fifth subcomponent is defined as 5s, the ratio 4s/5s may be 0.24 to 1.60.

When the 4s/5s is less than 0.24, the RC value may decrease, and when the 4s/5s exceeds 1.60, the room temperature dielectric constant and high temperature withstand voltage may decrease.

(Experimental Example)

The powder doped with Sn or Hf on the edge of the powder, which is the first main component, was prepared by a hydrothermal synthesis method. Pure BaTiO₃ powder, which is the second main component, was prepared by a solid-phase method or a hydrothermal synthesis method. The average particle size of the first main component powder was in the range of 100-400 nm, and the average particle size of the second main component powder was 150 nm.

The raw material powder including the main component and the subcomponent having the composition as in Tables 1, 3, 5 and 7 was milled for 10 hours using zirconia beads as a mixing/dispersing medium and adding and mixing with ethanol/toluene and a dispersing agent, the binder was mixed, and the milling was further performed for 10 hours. Using the prepared slurry, a molded sheet having a thickness of 4 μm was manufactured using a sheet forming machine. The Ni internal electrode was printed on the formed sheet. The upper and lower covers were manufactured by laminating a cover sheet (thickness of 10-13 μm) in 25 layers, and the 21 layers of printed active sheets was pressed and laminated, thereby manufacturing a bar. The bar was cut into chips having a size of 3.2 mm×1.6 mm using a cutter.

The manufactured 3216-sized chip was calcined, was baked for 1 hour at a temperature of 1150-1200° C. in a reducing atmosphere 1.0% H₂/99.0% N₂ (H₂O/H₂/N₂ atmosphere), and reoxidation was heat-treated for 3 hours at 1000° C. in N₂ atmosphere. A termination process and an electrode baking were performed on the baked chip using Cu paste, thereby forming an external electrode.

For the prototype multilayer ceramic capacitor (proto-type MLCC) sample manufactured as above, capacitance, a dissipation factor (DF), insulation resistance, Temperature Coefficient of Capacitance (TCC), resistance deterioration behavior according to an increase of voltage step at a high temperature of 150° C. were assessed.

The room temperature capacitance and dielectric loss of the MLCC Chip was measured under the conditions of 1 kHz and AC 0.5 V/μm using an LCR meter. The dielectric constant of the MLCC chip was calculated from the capacitance, the dielectric thickness of the MLCC chip, the area of the internal electrode, and the number of layers. The room temperature insulation resistance (IR) was measured by taking 10 samples, and applying DC 10 V/μm for 60 seconds. The change in capacitance according to temperature was measured in a temperature range of −55° C. to 125° C. In the high-temperature IR step-up experiment, the resistance degradation behavior was measured while increasing the voltage step by 5 V/μm at 150° C. The time for each step was 60 minutes, and the resistance value was measured at 10-second intervals. The high-temperature withstand voltage was derived from the high-temperature IR step-up experiment, which refers to a voltage in which the IR withstands 10⁵Ω or more when measured by applying a voltage step of DC 5 V/μm at 150° C. for 60 minutes in a 3216-size chip having 20 layers of dielectric, having a thickness of approximately 2.8 μm after sintering, and increasing this voltage step.

The RC value may be the product of the room temperature capacity value measured at AC 0.2 V/μm and 1 kHz and the insulation resistance value measured at DC 10 V/μm.

The area ratio of the first and second grains was obtained by analyzing the dielectric layer disposed in the center of the cross-sectional surface taken in the first and second directions of the center of the body in the third direction using STEM/EDS.

Specifically, an image was obtained by scanning region P in FIG. 2 using STEM as in FIG. 6, and the content of Sn or Hf in positions P1-P9 was analyzed by STEM/EDS analysis. When a line segment starting from the left side of the grain boundary and ending at the right side of the grain boundary is drawn in a single grain, and 9 points P1-P9 are taken with equal intervals, as in FIG. 7, the grain having both the point in which the atomic ratio of 2*Sn/(Ba+Ti+Sn) at points P2-P8 other than was 1.0% or more and 5.0% or less and the point in which the atomic ratio was less than 1.0 was determined as the first grain, and as in FIG. 8, the grain in which the atomic ratios of 2*Sn/(Ba+Ti) at the points P2-P8 were less than 1.0 was determined as the second grain. The Sn or Hf content was measured and calculated with respect to 30 grains.

Also, the size of the core of the first grain is a measurement of the size of the region in which 2*Sn/(Ba+Ti+Sn) was less than 1.0% in the graph as in FIG. 7.

In Tables 1, 3, 5 and 7, the contents of the first main component and the second main component refer to the respective molar ratios occupied in the main component, and the contents of the first to fifth subcomponents refer to mol content of each subcomponent based on 100 mol of the main component.

Tables 2, 4, 6, and 8 list properties of the prototype multilayer ceramic capacitors (prototype chips) corresponding to the example embodiments in Tables 1, 3, 5 and 7, respectively.

TABLE 3

| | First main | Second main | | | | | | | | |
|---|---|---|---|---|---|---|---|---|---|---|
| | component | component | First | | Second | Third | Fourth | | Fifth | |
| | Sn 0.5%- | BaTiO3 | subcomponent | | subcomponent | subcomponent | subcomponent | | subcomponent | (Ba + Ca)/Si |
| Embodiment | Shell BT | (BT) | MnO2 | V2O5 | MgCO3 | Dy2O3 | BaCO3 | CaCO3 | SiO2 | ratio |
| 1-1 | 0.000 | 1.000 | 0.200 | 0.100 | 1.00 | 0.50 | 2.40 | 0.00 | 1.65 | 1.45 |
| 1-2 | 0.000 | 1.000 | 0.200 | 0.100 | 1.00 | 0.50 | 0.80 | 0.00 | 1.65 | 0.48 |
| 1-3 | 0.300 | 0.700 | 0.200 | 0.100 | 1.00 | 0.50 | 0.80 | 0.00 | 1.65 | 0.48 |
| 1-4 | 0.500 | 0.500 | 0.200 | 0.100 | 1.00 | 0.50 | 0.80 | 0.00 | 1.65 | 0.48 |
| 1-5 | 0.800 | 0.200 | 0.200 | 0.100 | 1.00 | 0.50 | 0.80 | 0.00 | 1.65 | 0.48 |
| 1-6 | 1.000 | 0.000 | 0.200 | 0.100 | 1.00 | 0.50 | 0.80 | 0.00 | 1.65 | 0.48 |
| | Sn 1.0%- | BaTiO3 | | | | | | | | (Ba + Ca)/Si |
| | Shell BT | (BT) | MnO2 | V2O5 | MgCO3 | Dy2O3 | BaCO3 | CaCO3 | SiO2 | ratio |
| 2-1 | 0.200 | 0.800 | 0.200 | 0.100 | 1.00 | 0.50 | 0.80 | 0.00 | 1.65 | 0.48 |
| 2-2 | 0.300 | 0.700 | 0.200 | 0.100 | 1.00 | 0.50 | 0.80 | 0.00 | 1.65 | 0.48 |
| 2-3 | 0.500 | 0.500 | 0.200 | 0.100 | 1.00 | 0.50 | 0.80 | 0.00 | 1.65 | 0.48 |
| 2-4 | 0.800 | 0.200 | 0.200 | 0.100 | 1.00 | 0.50 | 0.80 | 0.00 | 1.65 | 0.48 |
| 2-5 | 1.000 | 0.000 | 0.200 | 0.100 | 1.00 | 0.50 | 0.80 | 0.00 | 1.65 | 0.48 |
| | Hf 1.0%- | BaTiO3 | | | | | | | | (Ba + Ca)/Si |
| | Shell BT | (BT) | MnO2 | V2O5 | MgCO3 | Dy2O3 | BaCO3 | CaCO3 | SiO2 | ratio |
| 3-1 | 0.200 | 0.800 | 0.200 | 0.100 | 1.00 | 0.50 | 0.80 | 0.00 | 1.65 | 0.48 |
| 3-2 | 0.300 | 0.700 | 0.200 | 0.100 | 1.00 | 0.50 | 0.80 | 0.00 | 1.65 | 0.48 |
| 3-3 | 0.500 | 0.500 | 0.200 | 0.100 | 1.00 | 0.50 | 0.80 | 0.00 | 1.65 | 0.48 |
| 3-4 | 0.800 | 0.200 | 0.200 | 0.100 | 1.00 | 0.50 | 0.80 | 0.00 | 1.65 | 0.48 |
| 3-5 | 1.000 | 0.000 | 0.200 | 0.100 | 1.00 | 0.50 | 0.80 | 0.00 | 1.65 | 0.48 |
| | Sn 5.0%- | BaTiO3 | | | | | | | | (Ba + Ca)/Si |
| | Shell BT | (BT) | MnO2 | V2O5 | MgCO3 | Dy2O3 | BaCO3 | CaCO3 | SiO2 | ratio |
| 4-1 | 0.200 | 0.800 | 0.200 | 0.100 | 1.00 | 0.50 | 0.80 | 0.00 | 1.65 | 0.48 |
| 4-2 | 0.300 | 0.700 | 0.200 | 0.100 | 1.00 | 0.50 | 0.80 | 0.00 | 1.65 | 0.48 |
| 4-3 | 0.500 | 0.500 | 0.200 | 0.100 | 1.00 | 0.50 | 0.80 | 0.00 | 1.65 | 0.48 |
| 4-4 | 0.800 | 0.200 | 0.200 | 0.100 | 1.00 | 0.50 | 0.80 | 0.00 | 1.65 | 0.48 |
| 4-5 | 1.000 | 0.000 | 0.200 | 0.100 | 1.00 | 0.50 | 0.80 | 0.00 | 1.65 | 0.48 |

TABLE 2

| | | | | | | | | | High | |
|---|---|---|---|---|---|---|---|---|---|---|
| | | | | | | | | | temperature | |
| | | | Room | | | | | DC-bias | (150° C.) | |
| | First | Second | temperature | | | | | dielectric | withstand | |
| | grain area | grain area | dielectric | DF | RC | TCC(%) | TCC(%) | constant | voltage | Properties |
| Embodiment | ratio(%) | ratio(%) | constant | (%) | (ΩF) | (−55° C.) | (125° C.) | @7 V/μm | (V/μm) | assessment |
| 1-1 | 0.0% | 100.0% | 2458 | 3.67 | 2365 | −13.5% | −17.4% | 1095 | 50 | X |
| 1-2 | 0.0% | 100.0% | 3854 | 6.85 | 1652 | −12.5% | −20.6% | 905 | 60 | X |
| 1-3 | 0.0% | 100.0% | 3786 | 6.42 | 1848 | −13.5% | −20.2% | 908 | 60 | X |
| 1-4 | 0.0% | 100.0% | 3805 | 6.69 | 1702 | −13.1% | −19.5% | 911 | 60 | X |
| 1-5 | 0.0% | 100.0% | 3616 | 5.84 | 2045 | −13.6% | −20.5% | 920 | 60 | X |
| 1-6 | 0.0% | 100.0% | 3520 | 5.27 | 2236 | −12.1% | −21.2% | 930 | 60 | X |
| 2-1 | 19.2% | 80.8% | 3020 | 4.83 | 2014 | −14.8% | −19.5% | 972 | 70 | X |
| 2-2 | 28.3% | 71.7% | 2750 | 3.87 | 2052 | −14.5% | −20.2% | 1105 | 70 | ◯ |
| 2-3 | 51.7% | 48.3% | 2684 | 3.55 | 2284 | −15.0% | −20.1% | 1134 | 75 | ◯ |
| 2-4 | 80.3% | 19.7% | 2605 | 3.48 | 2358 | −15.2% | −20.6% | 1156 | 75 | ◯ |
| 2-5 | 100.0% | 0.0% | 2387 | 3.36 | 2506 | −15.5% | −21.0% | 1187 | 75 | X |
| 3-1 | 23.4% | 76.6% | 2987 | 4.88 | 2564 | −15.2% | −18.4% | 988 | 65 | X |
| 3-2 | 31.3% | 68.7% | 2684 | 3.78 | 2121 | −14.3% | −20.5% | 1112 | 70 | ◯ |
| 3-3 | 50.5% | 49.5% | 2652 | 3.45 | 2123 | −15.6% | −20.4% | 1126 | 75 | ◯ |
| 3-4 | 80.3% | 19.7% | 2605 | 3.48 | 2358 | −15.2% | −20.6% | 1156 | 80 | ◯ |
| 3-5 | 100.0% | 0.0% | 2123 | 3.12 | 2695 | −16.2% | −20.5% | 1195 | 80 | X |
| 4-1 | 22.4% | 77.6% | 2883 | 4.05 | 2065 | −15.1% | −19.7% | 1025 | 75 | X |
| 4-2 | 29.5% | 70.5% | 2620 | 3.78 | 2113 | −15.5% | −19.6% | 1112 | 70 | ◯ |
| 4-3 | 53.4% | 46.6% | 2634 | 3.45 | 2388 | −15.2% | −20.4% | 1136 | 75 | ◯ |
| 4-4 | 82.3% | 17.7% | 2584 | 3.40 | 2456 | −15.5% | −20.8% | 1164 | 75 | ◯ |
| 4-5 | 100.0% | 0.0% | 2036 | 3.12 | 2849 | −16.4% | −23.5% | 1225 | 70 | X |

Tables 1 and 2 relate to changes in properties of the first main component while changing the content of Sn or Hf included in the shell and the ratio of the first main component and the second main component.

In embodiment 1-1 in Table 1, as for the main component, the second main component, BaTiO₃, was 100%, the sum of the variable valence elements (Mn, V) of the first subcomponent was 0.4 mol, the content of the second subcomponent Mg was 1.0 mol, the sum of the contents of the rare earth elements of the third subcomponent was 1.0 mol, the sum of the fourth subcomponents (Ba and Ca) was 2.4 mol, the content of the fifth subcomponent Si was 1.65 mol, and the ratio (Ba+Ca)/Si of the fourth subcomponent to the fifth subcomponent was 1.45, Table 2 lists the properties of the sample corresponding to embodiment 1-1.

The dielectric constant at DC 7 V/μm was 1095, which is more than the target 1050 in an example embodiment, but the room temperature dielectric constant was 2458, which is smaller than the target dielectric constant of 2500 or more, and the sintering density was low such that the high-temperature withstand voltage was 50 V/μm, and accordingly, the target value 65 V/μm in the example embodiment was not obtained.

Embodiments 1-2 to 1-6 in Table 1 are according to an increase of the ratio of the first main component when the sum of the variable valence elements (Mn and V) of the first subcomponent was 0.4 mol, the content of the second subcomponent Mg was 1.0 mol, the sum of the content of the third subcomponent rare earth element was 1.0 mol, the sum of the fourth subcomponent elements (Ba and Ca) was 0.8 mol, the content of the fifth subcomponent Si was 1.65 mol, the ratio (Ba+Ca)/Si of the fourth subcomponent to the fifth subcomponent was 0.48, and, when the first main component was Sn 0.5%-Shell BT having a shell having an atomic ratio of 2*Sn/(Ba+Ti+Sn) to be 0.5%. Embodiments 1-2 to 1-6 in Table 2 list the properties thereof. As the ratio of the first main component increases, the dielectric constant at DC 7 V/μm increases, but it may be impossible to obtain the target value of 1050 or more in the example embodiment even under the condition of 100% of the first main component.

Also, when the first main component is Sn 0.5%-Shell BT, it is confirmed that even when the ratio of the first main component is increased, grains satisfying the the conditions of the first grains in the example embodiment was not obtained.

When the first main component is Sn 1.0%-Shell BT having a shell having an atomic ratio of 2*Sn/(Ba+Ti+Sn) to be 1.0%, a condition which may implement the target properties in the example embodiment was found.

Embodiments 2-1 to 2-5 are according to the change in the ratio of Sn 1.0%-Shell BT in which the atomic ratio of 2*Sn/(Ba+Ti+Sn) of the shell region of the first main component was increased to 1.0%.

When the ratio of the first main component was as low as 20% (embodiment 2-1), the DC 7 V/μm dielectric constant was as low as 972, but when the ratio thereof was increased to 30-80% (embodiments 2-2 to 2-4) the properties of the room temperature dielectric constant ≥2500, dielectric constant ≥1050 at DC 7 V/μm, 150° C. high temperature withstand voltage ≥65 V/μm, RC value ≥1000 ΩF, TCC≤±22% in the temperature range of −55° C.-125° C. were satisfied. When the content of the first main component was further increased to 100%, the dielectric constant at DC 7 V/μm was further increased, but the room temperature dielectric constant as lowered to 2500 or less, such that the target properties in the example embodiment was not satisfied. In embodiments 2-2 to 2-4 in which the target properties in the example embodiment were implemented, the area ratio of the first grains was in the range of 28.3%-80.3%.

Embodiments 3-1 to 3-5 are according to a change in the ratio of Hf 1.0%-Shell BT in which the atomic ratio of 2*Hf/(Ba+Ti+Hf) of the shell region of the first main component was 1.0%.

Similarly to embodiments 2-1 to 2-5 to which Sn was applied, when the ratio of the first main component was in the range of 30-80% (embodiments 3-2 to 3-4), the properties of the dielectric constant ≥2500, dielectric constant at DC 7 V/μm≥1050, high-temperature withstand voltage at 150° C.≥65 V/μm, RC value ≥1000 ΩF, and TCC in the temperature range of −55° C.-125° C.≤±22% were satisfied. In this case, the area ratio of the first grains was in the range of 31.3%-80.3%. Therefore, the first main component or Sn and Hf solid-solute in the first grain may implement the same effect in the example embodiment.

Embodiments 4-1 to 4-5 are according to the change of the ratio of Sn 5.0%-Shell BT in which the atomic ratio of 2*Sn/(Ba+Ti+Sn) of the shell region of the first main component was increased to 5.0%.

Even when the atomic ratio of 2*Sn/(Ba+Ti+Sn) of the shell region of the first main component was increased to 5.0%, the embodiment has the same tendency as in embodiments 2-1 to 2-5 in which the atomic ratio of 2*Sn/(Ba+Ti+Sn) of the shell region of the first main component was 1.0%. When the ratio of the first main component was as low as 20% (embodiment 4-1), the DC 7 V/μm dielectric constant was as low as 988, but when the ratio was increased to 30-80% (embodiments 4-2 to 4-4) the properties of the room temperature dielectric constant≥2500, dielectric constant at DC 7 V/μm≥1050, 150° C. high temperature withstand voltage≥65 V/μm, RC value≥1000 ΩF, TCC in the temperature range of −55° C.-125° C.≤±22% were satisfied. When the content of the first main component was further increased to 100%, the dielectric constant at DC 7 V/μm was further increased, but the room temperature dielectric constant was lowered to 2500 or less, such that the target properties in the example embodiment were not satisfied. In embodiments 4-2 to 4-4 in which the target properties in the example embodiment are implemented, the area ratio of the first grains was in the range of 29.5%-82.3%.

Accordingly, when the area ratio of the first grains satisfied 28.3%-82.3%, the target properties in the example embodiment was implemented.

Also, the atomic ratio of 2*Sn/(Ba+Ti+Sn) or 2*Hf/(Ba+Ti+Hf) of the shell region of the first main component was 1.0% or more and 5.0% or less, and the ratio was 30-80%, the target properties in the example embodiment was implemented.

In the example embodiment, the powder was synthesized such that the atomic ratio of 2*Sn/(Ba+Ti+Sn) or 2*Hf/(Ba+Ti+Hf) of the shell region of the first main component exceeds 5.0%, which is high, uniformity was degraded due to the formation of a secondary phase in which Sn or Hf components were aggregated, such that it was not possible to assess the sample. Thus, the atomic ratio of 2*Sn/(Ba+Ti+Sn) or 2*Hf/(Ba+Ti+Hf) of the shell region of the first main component maybe preferably 1.0% or more and 5.0% or less.

TABLE 3

| | First main | Second main | | | | | | | | |
|---|---|---|---|---|---|---|---|---|---|---|
| | component | component | | | | | | | | |
| | Sn 1%-Shell | BaTiO3 | First | | Second | Third | Fourth | | Fifth | |
| | BTratio/ | (BT) | subcomponent | | subcomponent | subcomponent | subcomponent | | subcomponent | (Ba + Ca)/Si |
| Embodiment | Core size | ratio | MnO2 | V2O5 | MgCO3 | Dy2O3 | BaCO3 | CaCO3 | SiO2 | ratio |
| 5-1 | 0.5/25 nm | 0.5 | 0.200 | 0.100 | 1.00 | 0.50 | 0.80 | 0.00 | 1.65 | 0.48 |
| 5-2 | 0.50/40 nm | 0.5 | 0.200 | 0.100 | 1.00 | 0.50 | 0.80 | 0.00 | 1.65 | 0.48 |
| 5-3 | 0.50/100 nm | 0.5 | 0.200 | 0.100 | 1.00 | 0.50 | 0.80 | 0.00 | 1.65 | 0.48 |
| 5-4 | 0.50/200 nm | 0.5 | 0.200 | 0.100 | 1.00 | 0.50 | 0.80 | 0.00 | 1.65 | 0.48 |
| 5-5 | 0.50/280 nm | 0.5 | 0.200 | 0.100 | 1.00 | 0.50 | 0.80 | 0.00 | 1.65 | 0.48 |

TABLE 4

| | | | | | | | | | Hgh | |
|---|---|---|---|---|---|---|---|---|---|---|
| | First | | Room | | | | | DC-bias | temperature(150° C.) | |
| | grain area | Second | temperature | | | | | dielectric | withstand | |
| | ratio(%)/ | grain area | dielectric | DF | RC | TCC(%) | TCC(%) | constant | voltage | Properties |
| Embodiment | Core size | ratio(%) | constant | (%) | (ΩF) | (−55° C.) | (125° C.) | @7 V/μm | (V/μm) | assessment |
| 5-1 | 49.0%/30 nm | 51.0% | 2268 | 2.88 | 2693 | −20.5% | −24.2% | 1221 | 75 | X |
| 5-2 | 52.5%/50 nm | 47.5% | 2534 | 3.46 | 2372 | −18.4% | −21.0% | 1167 | 75 | ◯ |
| 5-3 | 48.5%/120 nm | 51.5% | 2684 | 3.55 | 2284 | −15.0% | −20.1% | 1134 | 75 | ◯ |
| 5-4 | 49.2%/250 nm | 50.8% | 2812 | 3.75 | 2045 | −14.8% | −18.5% | 1105 | 70 | ◯ |
| 5-5 | 48.1%/300 nm | 51.9% | 3154 | 4.12 | 1864 | −14.5% | −17.4% | 965 | 50 | X |

Embodiments 5-1 to 5-5 are to observe the changes in the properties according to the size of the core of the first main component and the first grain.

The first main component was Sn 1.0%-Shell BT having an atomic ratio of 2*Sn/(Ba+Ti+Sn) of 1.0% in the shell region, the ratio of the first main component was the same as 50%, and the sum of the variable valence elements (Mn and V) of the first subcomponent was 0.4 mol, the content of the second subcomponent Mg was 1.0 mol, the sum of the contents of the third subcomponent rare earth element was 1.0 mol, the sum of the fourth subcomponent elements (Ba and Ca) was 0.8 mol, the content of the fifth subcomponent Si was 1.65 mol, and the ratio of the fourth subcomponent to the fifth subcomponent (Ba+Ca)/Si was 0.48. The area ratio of the first grain in embodiments 5-1 to 5-5 was in the range of 48.1%-52.5%, which was similar to each other. When the size of the core region of the first grain was relatively low as 30 nm (embodiment 5-1), the room temperature dielectric constant was less than 2500, and the TCC (125° C.) was beyond the range of ±22%, such that the target properties in the example embodiment was not implemented.

When the core size of the first grains was in the range of 50-250 nm (embodiments 5-2 to 5-4), the properties of dielectric constant 2500, dielectric constant at DC 7 V/μm 1050, 150° C. high temperature withstand voltage ≥65 V/μm, RC value ≥1000 ΩF, TCC in the temperature range of −55° C.-125° C. ≤±22% were satisfied.

When the core size of the first grains was relatively large as 300 nm (embodiment 5-5), the dielectric constant at DC 7 V/μm was less than 1050, and the 150° C. high-temperature withstand voltage was also lowered to less than 65 V/μm, such that target properties in the example embodiment were not implemented.

Therefore, to implement the target properties in the example embodiment, the core size of the first grains may be 50-250 nm preferably. Also, to implement the target properties in the example embodiment, the core size of the first main component may be 40-200 nm preferably.

TABLE 5

| | First main | Second main | | | | | | | | |
|---|---|---|---|---|---|---|---|---|---|---|
| | component | component | First | | Second | Third | Fourth | | Fifth | |
| | Sn 1.0%- | BaTiO3 | subcomponent | | subcomponent | subcomponent | subcomponent | | subcomponent | (Ba + Ca)/Si |
| Embodiment | Shell BT | (BT) | MnO2 | V2O5 | MgCO3 | Dy2O3 | BaCO3 | CaCO3 | SiO2 | ratio |
| 6-1 | 0.500 | 0.500 | 0.200 | 0.100 | 1.00 | 0.20 | 0.80 | 0.00 | 1.65 | 0.48 |
| 6-2 | 0.500 | 0.500 | 0.200 | 0.100 | 1.00 | 0.30 | 0.80 | 0.00 | 1.65 | 0.48 |
| 6-3 | 0.500 | 0.500 | 0.200 | 0.100 | 1.00 | 0.50 | 0.80 | 0.00 | 1.65 | 0.48 |
| 6-4 | 0.500 | 0.500 | 0.200 | 0.100 | 1.00 | 1.50 | 0.80 | 0.00 | 1.65 | 0.48 |
| 6-5 | 0.500 | 0.500 | 0.200 | 0.100 | 1.00 | 2.00 | 0.80 | 0.00 | 1.65 | 0.48 |
| 7-1 | 0.500 | 0.500 | 0.200 | 0.100 | 0.00 | 0.50 | 0.80 | 0.00 | 1.65 | 0.48 |
| 7-2 | 0.500 | 0.500 | 0.200 | 0.100 | 1.00 | 0.50 | 0.80 | 0.00 | 1.65 | 0.48 |
| 7-3 | 0.500 | 0.500 | 0.200 | 0.100 | 2.00 | 0.50 | 0.80 | 0.00 | 1.65 | 0.48 |
| 7-4 | 0.500 | 0.500 | 0.200 | 0.100 | 2.50 | 0.50 | 0.80 | 0.00 | 1.65 | 0.48 |
| 8-1 | 0.500 | 0.500 | 0.050 | 0.025 | 1.00 | 0.50 | 0.80 | 0.00 | 1.65 | 0.48 |
| 8-2 | 0.500 | 0.500 | 0.100 | 0.050 | 1.00 | 0.50 | 0.80 | 0.00 | 1.65 | 0.48 |
| 8-3 | 0.500 | 0.500 | 0.700 | 0.350 | 1.00 | 0.50 | 0.80 | 0.00 | 1.65 | 0.48 |
| 8-4 | 0.500 | 0.500 | 1.000 | 0.500 | 1.00 | 0.50 | 0.80 | 0.00 | 1.65 | 0.48 |
| 8-5 | 0.500 | 0.500 | 0.500 | 0.000 | 1.00 | 0.50 | 0.80 | 0.00 | 1.65 | 0.48 |
| 8-6 | 0.500 | 0.500 | 0.000 | 0.250 | 1.00 | 0.50 | 0.80 | 0.00 | 1.65 | 0.48 |

TABLE 6

| | | | | | | | | | High | |
|---|---|---|---|---|---|---|---|---|---|---|
| | | | Room | | | | | DC-bias | temperature(150°C) | |
| | First | Second | temperature | | | | | dielectric | withstand | |
| | grain area | grain area | dielectric | DF | RC | TCC(%) | TCC(%) | constant | voltage | Properties |
| Embodiment | ratio(%) | ratio(%) | constant | (%) | (ΩF) | (−55° C.) | (125° C.) | @7 V/μm | (V/μm) | assessment |
| 6-1 | 48.4% | 51.6% | 2563 | 3.47 | 2365 | −12.4% | −14.6% | 1152 | 55 | X |
| 6-2 | 53.2% | 46.8% | 2650 | 3.51 | 2345 | −14.2% | −18.2% | 1147 | 65 | ◯ |
| 6-3 | 49.5% | 50.5% | 2684 | 3.55 | 2284 | −15.0% | −20.1% | 1134 | 75 | ◯ |
| 6-4 | 47.3% | 52.7% | 2508 | 3.17 | 2840 | −18.4% | −21.0% | 1162 | 70 | ◯ |
| 6-5 | 46.5% | 53.5% | 2240 | 2.65 | 3002 | −21.5% | −24.6% | 1212 | 40 | X |
| 7-1 | 53.4% | 46.6% | 2532 | 3.45 | 1230 | −14.5% | −19.2% | 1141 | 70 | ◯ |
| 7-2 | 52.6% | 47.4% | 2684 | 3.55 | 2284 | −15.0% | −20.1% | 1134 | 75 | ◯ |
| 7-3 | 51.2% | 48.8% | 2788 | 3.92 | 2456 | −15.4% | −20.8% | 1084 | 65 | ◯ |
| 7-4 | 50.3% | 49.7% | 2873 | 4.32 | 2785 | −15.6% | −21.0% | 1037 | 55 | X |
| 8-1 | 52.7% | 47.3% | 2657 | 3.64 | 2312 | −15.5% | −19.4% | 1123 | 45 | X |
| 8-2 | 50.5% | 49.5% | 2684 | 3.55 | 2284 | −15.0% | −20.1% | 1134 | 75 | ◯ |
| 8-3 | 46.8% | 53.2% | 2623 | 3.45 | 1352 | −14.8% | −19.2% | 1105 | 75 | ◯ |
| 8-4 | 47.4% | 52.6% | 2456 | 3.37 | 884 | −14.2% | −19.0% | 1117 | 55 | X |
| 8-5 | 49.2% | 50.8% | 2673 | 3.67 | 2341 | −15.5% | −20.6% | 1125 | 75 | ◯ |
| 8-6 | 51.1% | 48.9% | 2626 | 3.62 | 1640 | −16.2% | −19.7% | 1145 | 75 | ◯ |

Embodiments 6-1 to 6-5 are to observe the change in the properties according to the content of the third subcomponent.

When the content of the third subcomponent Dy2O₃ was low as 0.2 mol (0.4 mol as the content of the Dy element) (embodiment 6-1), high-temperature withstand voltage properties were lowered to less than the target value of 65 V/μm in an example embodiment, such that the target properties in an example embodiment was not implemented.

Also, even when the content of Dy₂O₃ was relatively large as 2.0 mol (4.0 mol as the content of Dy element) (embodiment 6-5), high-temperature withstand voltage properties were less than 65 V/μm, such that the target properties in the example embodiment was not implemented.

When the content of Dy₂O₃ was in the range of 0.3-1.5 mol (0.6-3.0 mol as the content of element Dy) (embodiments 6-2 to 6-4), the room temperature dielectric constant ≥2500, the dielectric constant at DC 7 V/μm ≥1050, 150° C. high-temperature withstand voltage ≥65 V/μm, RC value ≥1000 ΩF, and TCC in the temperature range of −55° C.-125° C. ≤±22% were satisfied.

Embodiments 7-1 to 7-4 are to observe the change in properties according to the content of the second subcomponent.

Mg of the second subcomponent may increase the RC value. However, when the content of MgCO₃ is 2.5 mol (2.5 mol as Mg element content), which is excessive, (embodiment 7-4), high-temperature withstand voltage properties were less than 65 V/μm, such that the target properties in the example embodiment were not implemented. When the content of MgCO₃ is in the range of 0-2.0 mol (0-2.0 mol as the content of element Mg) (embodiments 7-1 to 7-3), the properties in the example embodiment were implemented.

Embodiments 8-1 to 8-6 are to observe the change in the properties according to the content of the first subcomponent.

When the sum of the contents of the Mn element and the V element, which are variable valence acceptor elements, was excessively low as 0.1 mol (embodiment 8-1), high-temperature withstand voltage properties were lower than 65 V/μm, and the target properties in the example embodiment were implemented.

Also, when the sum of the contents of the Mn element and the V element was excessive as 2.0 mol % (embodiment 8-4), the RC value was less than 1000, which may not satisfy the target properties in the example embodiment. In embodiment 8-5, an Mn element content was 0.5 mol, and in embodiment 8-6, a V element content was 0.5 mol. In both embodiments, all properties in the example embodiment were implemented. Therefore, to implement the target properties in the example embodiment, in the content of the first subcomponent, the total content of the variable valence acceptor elements maybe 0.2 mol to 1.4 mol, preferably.

TABLE 7

| | First main | Second main | | | | | | | | |
|---|---|---|---|---|---|---|---|---|---|---|
| | component | component | First | | Second | Third | Fourth | | Fifth | |
| | Sn 1.0%- | BaTiO3 | subcomponent | | subcomponent | subcomponent | subcomponent | | subcomponent | (Ba + Ca)/Si |
| Embodiment | Shell BT | (BT) | MnO2 | V2O5 | MgCO3 | Dy2O3 | BaCO3 | CaCO3 | SiO2 | ratio |
| 9-1 | 0.500 | 0.500 | 0.200 | 0.100 | 1.00 | 0.50 | 0.00 | 0.00 | 0.50 | 0.00 |
| 9-2 | 0.500 | 0.500 | 0.200 | 0.100 | 1.00 | 0.50 | 0.24 | 0.00 | 0.50 | 0.48 |
| 9-3 | 0.500 | 0.500 | 0.200 | 0.100 | 1.00 | 0.50 | 1.00 | 0.00 | 0.50 | 2.00 |
| 10-1 | 0.500 | 0.500 | 0.200 | 0.100 | 1.00 | 0.50 | 0.10 | 0.00 | 0.80 | 0.12 |
| 10-2 | 0.500 | 0.500 | 0.200 | 0.100 | 1.00 | 0.50 | 0.19 | 0.00 | 0.80 | 0.24 |
| 10-3 | 0.500 | 0.500 | 0.200 | 0.100 | 1.00 | 0.50 | 0.38 | 0.00 | 0.80 | 0.48 |
| 10-4 | 0.500 | 0.500 | 0.200 | 0.100 | 1.00 | 0.50 | 1.28 | 0.00 | 0.80 | 1.60 |
| 10-5 | 0.500 | 0.500 | 0.200 | 0.100 | 1.00 | 0.50 | 1.50 | 0.00 | 0.80 | 1.88 |
| 11-1 | 0.500 | 0.500 | 0.200 | 0.100 | 1.00 | 0.50 | 0.20 | 0.00 | 1.65 | 0.12 |
| 11-2 | 0.500 | 0.500 | 0.200 | 0.100 | 1.00 | 0.50 | 0.40 | 0.00 | 1.65 | 0.24 |
| 11-3 | 0.500 | 0.500 | 0.200 | 0.100 | 1.00 | 0.50 | 0.80 | 0.00 | 1.65 | 0.48 |
| 11-4 | 0.500 | 0.500 | 0.200 | 0.100 | 1.00 | 0.50 | 2.64 | 0.00 | 1.65 | 1.60 |
| 11-5 | 0.500 | 0.500 | 0.200 | 0.100 | 1.00 | 0.50 | 3.10 | 0.00 | 1.65 | 1.88 |
| 11-6 | 0.500 | 0.500 | 0.200 | 0.100 | 1.00 | 0.50 | 0.40 | 0.40 | 1.65 | 0.48 |
| 11-7 | 0.500 | 0.500 | 0.200 | 0.100 | 1.00 | 0.50 | 0.00 | 0.80 | 1.65 | 0.48 |
| 12-1 | 0.500 | 0.500 | 0.200 | 0.100 | 1.00 | 0.50 | 0.36 | 0.00 | 3.00 | 0.12 |
| 12-2 | 0.500 | 0.500 | 0.200 | 0.100 | 1.00 | 0.50 | 0.72 | 0.00 | 3.00 | 0.24 |
| 12-3 | 0.500 | 0.500 | 0.200 | 0.100 | 1.00 | 0.50 | 1.45 | 0.00 | 3.00 | 0.48 |
| 12-4 | 0.500 | 0.500 | 0.200 | 0.100 | 1.00 | 0.50 | 4.80 | 0.00 | 3.00 | 1.60 |
| 12-5 | 0.500 | 0.500 | 0.200 | 0.100 | 1.00 | 0.50 | 5.63 | 0.00 | 3.00 | 1.88 |
| 13-1 | 0.500 | 0.500 | 0.200 | 0.100 | 1.00 | 0.50 | 1.92 | 0.00 | 4.00 | 0.48 |
| 13-2 | 0.500 | 0.500 | 0.200 | 0.100 | 1.00 | 0.50 | 6.40 | 0.00 | 4.00 | 1.60 |

TABLE 8

| | | | | | | | | | High | |
|---|---|---|---|---|---|---|---|---|---|---|
| | | | Room | | | | | DC-bias | temperature(150° C.) | |
| | first | Second | temperature | | | | | dielectric | withstand | |
| | grain area | grain area | dielectric | DF | RC | TCC(%) | TCC(%) | constant | voltage | Properties |
| Embodiment | ratio(%) | ratio(%) | constant | (%) | (ΩF) | (−55° C.) | (125° C.) | @7 V/μm | (V/μm) | assessment |
| 9-1 | 48.6% | 51.4% | 1580 | 1.52 | 1135 | — | — | — | 15 | X |
| 9-2 | 49.2% | 50.8% | 1764 | 1.63 | 1250 | — | — | — | 20 | X |
| 9-3 | 46.4% | 53.6% | 1477 | 1.47 | 985 | — | — | — | 10 | X |
| 10-1 | 52.3% | 47.7% | 2512 | 3.15 | 986 | −13.8% | −14.5% | 1155 | 70 | X |
| 10-2 | 51.0% | 49.0% | 2587 | 3.36 | 1950 | −14.2% | −19.5% | 1152 | 70 | ◯ |
| 10-3 | 50.7% | 49.3% | 2678 | 3.65 | 2345 | −15.1% | −19.2% | 1124 | 75 | ◯ |
| 10-4 | 49.2% | 50.8% | 2523 | 3.48 | 2564 | −16.2% | −19.5% | 1135 | 70 | ◯ |
| 10-5 | 48.4% | 51.6% | 2036 | 2.89 | 2417 | −13.5% | −14.8% | 1178 | 50 | X |
| 11-1 | 52.3% | 47.7% | 2555 | 3.69 | 941 | −14.5% | −15.2% | 1150 | 70 | X |
| 11-2 | 54.1% | 45.9% | 2632 | 3.47 | 2020 | −14.5% | −20.4% | 1148 | 70 | ◯ |
| 11-3 | 48.5% | 51.5% | 2684 | 3.55 | 2284 | −15.0% | −20.1% | 1134 | 75 | ◯ |
| 11-4 | 47.6% | 52.4% | 2635 | 3.86 | 2413 | −15.8% | −20.3% | 1088 | 70 | ◯ |
| 11-5 | 49.2% | 50.8% | 1856 | 2.65 | 1852 | −13.2% | −14.5% | 1185 | 50 | X |
| 11-6 | 50.4% | 49.6% | 2684 | 3.55 | 2284 | −15.0% | −20.1% | 1134 | 75 | ◯ |
| 11-7 | 53.1% | 46.9% | 2578 | 3.45 | 2175 | −16.2% | −9.5% | 1132 | 75 | ◯ |
| 12-1 | 47.1% | 52.9% | 2503 | 3.64 | 954 | −14.6% | −16.4% | 1053 | 65 | X |
| 12-2 | 48.2% | 51.8% | 2625 | 3.58 | 2111 | −14.8% | −19.5% | 1085 | 65 | ◯ |
| 12-3 | 50.7% | 49.3% | 2613 | 3.47 | 2078 | −15.0% | −20.1% | 1062 | 70 | ◯ |
| 12-4 | 49.3% | 50.7% | 2561 | 3.94 | 2071 | −16.2% | −20.4% | 1055 | 65 | ◯ |
| 12-5 | 52.2% | 47.8% | 1745 | 2.37 | 1784 | −13.8% | −15.2% | 1112 | 40 | X |
| 13-1 | 51.3% | 48.7% | 2458 | 3.98 | 1952 | −15.5% | −20.4% | 1031 | 60 | X |
| 13-2 | 48.5% | 51.5% | 2346 | 4.11 | 2238 | −16.7% | −17.4% | 996 | 40 | X |

Embodiments 9-1 to 13-2 are to observe the changes in the properties according to the fourth subcomponent, the fifth subcomponent, and the ratio thereof.

When the content of the fifth subcomponent SiO₂ is as low as 0.5 mol (embodiments 9-1 to 9-3), baking density was low regardless of the content of the fourth subcomponent, such that the room temperature dielectric constant and high temperature withstand voltage were less than the target values in the example embodiment, and thus, the target properties in the example embodiment was not implemented.

Embodiments 10-1 to 10-5 are according to the change in the content of the fourth subcomponent BaCO₃ when the content of the fifth subcomponent SiO₂ was 0.8 mol. When the Ba element content was extremely low as 0.1 mol (embodiment 10-1), the RC value was less than the target value of 1000 in the example embodiment, and when the content was excessive as 1.5 mol (embodiment 10-5), the room temperature dielectric constant and high temperature withstand voltage were lower than the target values of 2500 and 65 V/μm in the example embodiment.

Embodiments 10-2 to 10-4 satisfied the dielectric constant 2500, the dielectric constant at DC 7 V/μm ≥1050, 150° C. high-temperature withstand voltage ≥65 V/μm, RC value ≥1000 ΩF, and TCC in the temperature range of −55° C.-125° C.≥±22%, and in this case, the ratio (Ba+Ca)/Si of the fourth and fifth subcomponents was in the range of 0.24-1.60.

Embodiments 11-1 to 11-7 are according to the change in the content of the fourth subcomponent BaCO₃ when the content of the fifth subcomponent SiO₂ was 1.65 mol (the content of the Si element was 1.65 mol). When the content of the fourth subcomponent Ba was excessively small (embodiment 11-1) or excessively large (embodiment 11-5), the target properties in the example embodiment were not implemented, and when the ratio (Ba+Ca)/Si of the fourth and fifth subcomponents was within the range of 0.24-1.60 (embodiments 11-2 to 11-4), the target properties in the example embodiment were implemented. Embodiments 11-6 and 11-7 indicate properties when a portion or an entirety of Ba was changed to Ca, and it is indicated that the same properties were implemented.

Embodiments 12-1 to 12-5 are according to the change in the content of the fourth subcomponent BaCO₃ when the content of the fifth subcomponent SiO₂ is 3.0 mol (the content of the Si element was 3.0 mol) . As in embodiments 11 to 1-11-7, when the ratio (Ba+Ca)/Si of the fourth and fifth subcomponents was in the range of 0.24-1.60 (embodiment 12-2-12-4), the target properties in the example embodiment may be implemented.

Embodiments 13-1 to 13-2 are according to the change in the BaCO₃ content when the content of the fifth subcomponent SiO₂ was 4.0 mol, and in this case, even when the ratio (Ba+Ca)/Si of the fourth and fifth subcomponents is in the range of 0.24-1.60, the room temperature dielectric constant, the dielectric constant at DC 7 V/μm, and the high-temperature withstand voltage were lower than the target values in the example embodiment such that the target properties were not satisfied.

According to the change in the properties according to the fourth subcomponent, the fifth subcomponent, and the ratios thereof, to implement the properties in the example embodiment, the total content of one or more of Ba and Ca included in the fourth subcomponent may be 0.19 mol to 4.8 mol preferably, the content of the Si element included in the fifth subcomponent may be 0.8 mol to 3.0 mol based on 100 mol of the main component preferably, and the (Ba+Ca)/Si ratio may be in the range of 0.24-1.60 preferably.

According to the aforementioned example embodiments, by controlling the area of the grain of the core-shell structure including Sn or Hf in the shell, the room temperature dielectric constant, the DC-bias properties, and high-temperature withstand voltage properties may improve.

Also, a multilayer electronic component which may satisfy X7R or X7S capacitance temperature properties, and a dielectric composition may be provided.

While the example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including a dielectric layer and an internal electrode; and
an external electrode disposed on the body and connected to the internal electrode,
wherein the dielectric layer includes first and second grains,
wherein the first grain has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second grain has an atomic ratio of 2*Sn/(Ba+Ti+Sn) and 2*Hf/(Ba+Ti+Hf) to be less than 1.0%, and
wherein an area occupied by the first grain in an entire area of the first and second grains is 28.3-82.3%.

2. The multilayer electronic component of claim 1, wherein Sn or Hf is solid-solute in BaTiO₃ in the first and second grains.

3. The multilayer electronic component of claim 1, wherein a size of the core of the first grain is 50 nm or more and 250 nm or less.

4. The multilayer electronic component of claim 1, wherein, as properties of the multilayer electronic component:
a room temperature dielectric constant satisfies 2500 or more,
a DC-bias dielectric constant at 7 V/μm satisfies 1050 or more,
a withstanding voltage at 150° C. satisfies 65 V/μm or more,
an RC value satisfies 1000 ΩF or higher, and
a TCC at −55° C. and 125° C. satisfies −22% to 22%.

5. The multilayer electronic component of claim 1,
wherein the dielectric layer is formed using a dielectric composition,
wherein the dielectric composition includes a main component including first and second main components based on BaTiO₃,
wherein the first main component has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second main component has an atomic ratio of 2*Sn/(Ba+Ti+Sn) and 2*Hf/(Ba+Ti+Hf) to be less than 1.0%, and
wherein, when a molar ratio of the first main component is defined as x and a molar ratio of the second main component is defined as 1-x, x is 0.3-0.8.

6. The multilayer electronic component of claim 5,
wherein the dielectric composition further includes a first subcomponent including one or more of an oxide or a carbonate of a variable valence acceptor element,
wherein the variable valence acceptor element includes one or more of Mn, V, Cr, Fe, Ni, Co, Cu and Zn, and
wherein a content of the variable valence acceptor element included in the first subcomponent is 0.2 mol to 1.4 mol based on 100 mol of the main component.

7. The multilayer electronic component of claim 5,
wherein the dielectric composition further includes a second subcomponent including one or more of an oxide or a carbonate of Mg, and
wherein a content of an Mg element included in the second subcomponent is 2.0 mol or less based on 100 mol of the main component.

8. The multilayer electronic component of claim 5,
wherein the dielectric composition further includes a third subcomponent including one or more of an oxide and a carbonate of a rare earth element,
wherein the rare earth element includes one or more of Y, Dy, Ho, Er, Gd, Ce, Nd, Sm, Tb, Tm, La, Gd and Yb, and
wherein a content of the rare earth element included in the third subcomponent is 0.6 mol to 3.0 mol based on 100 mol of the main component.

9. The multilayer electronic component of claim 5,
wherein the dielectric composition further includes a fourth subcomponent including one or more of an oxide and a carbonate of one or more of Ba and Ca, and
wherein a sum of contents of one or more of Ba and Ca included in the fourth subcomponent is 0.19 mol to 4.8 mol based on 100 mol of the main component.

10. The multilayer electronic component of claim 5,
wherein the dielectric composition further includes a fifth subcomponent including one or more of an oxide of Si, a carbonate of Si, and a glass including Si, and
wherein a content of an Si element included in the fifth subcomponent is 0.8 mol to 3.0 mol based on 100 mol of the main component.

11. The multilayer electronic component of claim 5,
wherein the dielectric composition further includes a fourth subcomponent and a fifth subcomponent,
wherein the fourth subcomponent includes one or more of an oxide and a carbonate of one or more of Ba and Ca,
wherein the fifth subcomponent includes one or more of an oxide of Si, a carbonate of Si, and a glass including Si,
wherein a content of an Si element included in the fifth subcomponent is 0.8 mol to 3.0 mol based on 100 mol of the main component, and
wherein, when a sum of contents of one or more of Ba and Ca included in the fourth subcomponent is defined as 4s, and a content of an Si element included in the fifth subcomponent is defined as 5s, the ratio 4s/5s is 0.24 to 1.60.

12. A multilayer electronic component, comprising:
a dielectric composition including a main component, the main component including first and second main components based on BaTiO₃,
wherein the first main component has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second main component has an atomic ratio of 2*Sn/(Ba+Ti+Sn) and 2*Hf/(Ba+Ti+Hf) to be less than 1.0%, and
wherein, when a molar ratio of the first main component is defined as x and a molar ratio of the second main component is defined as 1-x, x is 0.3-0.8.

13. The multilayer electronic component of claim 12,
wherein the dielectric composition further includes a first subcomponent including one or more of an oxide or a carbonate of a variable valence acceptor element,
wherein the variable valence acceptor element includes one or more of Mn, V, Cr, Fe, Ni, Co, Cu and Zn, and
wherein a content of the variable valence acceptor element included in the first subcomponent is 0.2 mol to 1.4 mol based on 100 mol of the main component.

14. The multilayer electronic component of claim 12,
wherein the dielectric composition further includes a second subcomponent including one or more of an oxide or a carbonate of Mg, and
wherein a content of an Mg element included in the second subcomponent is 2.0 mol or less based on 100 mol of the main component.

15. The multilayer electronic component of claim 12,
wherein the dielectric composition further includes a third subcomponent including one or more of an oxide and a carbonate of a rare earth element,
wherein the rare earth element includes one or more of Y, Dy, Ho, Er, Gd, Ce, Nd, Sm, Tb, Tm, La, Gd and Yb, and
wherein a content of the rare earth element included in the third subcomponent is 0.6 mol to 3.0 mol based on 100 mol of the main component.

16. The multilayer electronic component of claim 12,
wherein the dielectric composition further includes a fourth subcomponent including one or more of an oxide and a carbonate of one or more of Ba and Ca, and
wherein a sum of contents of one or more of Ba and Ca included in the fourth subcomponent is 0.19 mol to 4.8 mol based on 100 mol of the main component.

17. The multilayer electronic component of claim 12,
wherein the dielectric composition further includes a fifth subcomponent including one or more of an oxide of Si, a carbonate of Si, and a glass including Si, and
wherein a content of an Si element included in the fifth subcomponent is 0.8 mol to 3.0 mol based on 100 mol of the main component.

18. The multilayer electronic component of claim 12,
wherein the dielectric composition further includes a fourth subcomponent and a fifth subcomponent,
wherein the fourth subcomponent includes one or more of an oxide and a carbonate of one or more of Ba and Ca,
wherein the fifth subcomponent includes one or more of an oxide of Si, a carbonate of Si, and a glass including Si,
wherein a content of an Si element included in the fifth subcomponent is 0.8 mol to 3.0 mol based on 100 mol of the main component, and
wherein, when a sum of contents of one or more of Ba and Ca included in the fourth subcomponent is defined as 4s and a content of an Si element included in the fifth subcomponent is defined as 5s, the ratio 4s/5s is 0.24 to 1.60.

19. The multilayer electronic component of claim 12, wherein a size of the core of the first main component is 40-200nm.

20. A multilayer electronic component, comprising:
a dielectric layer including first and second grains,
wherein the first grain has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second grain has an atomic ratio of 2*Sn/(Ba+Ti+Sn) and 2*Hf/(Ba+Ti+Hf) to be less than 1.0%, and
wherein a size of the core of the first grain is 50 nm or more and 250 nm or less.

21. The multilayer electronic component of claim 20, wherein Sn or Hf is solid-solute in BaTiO₃ in the first and second grains.

22. The multilayer electronic component of claim 20, wherein an area occupied by the first grain in an entire area of the first and second grains is 28.3-82.3%.

23. The multilayer electronic component of claim 20, wherein, as properties of the multilayer electronic component:
a room temperature dielectric constant satisfies 2500 or more,
a DC-bias dielectric constant at 7 V/μm satisfies 1050 or more,
a withstanding voltage at 150° C. satisfies 65 V/μm or more,
an RC value satisfies 1000 ΩF or higher, and
a TCC at −55° C. and 125° C. satisfies −22% to 22%.

24. The multilayer electronic component of claim 20,
wherein the dielectric layer is formed using a dielectric composition,
wherein the dielectric composition includes a main component including first and second main components based on BaTiO₃,
wherein the first main component has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second main component has an atomic ratio of 2*Sn/(Ba+Ti+Sn) and 2*Hf/(Ba+Ti+Hf) to be less than 1.0%, and
wherein, when a molar ratio of the first main component is defined as x and a molar ratio of the second main component is defined as 1-x, x is 0.3-0.8.

25. The multilayer electronic component of claim 24,
wherein the dielectric composition further includes a first subcomponent including one or more of an oxide or a carbonate of a variable valence acceptor element,
wherein the variable valence acceptor element includes one or more of Mn, V, Cr, Fe, Ni, Co, Cu and Zn, and
wherein a content of the variable valence acceptor element included in the first subcomponent is 0.2 mol to 1.4 mol based on 100 mol of the main component.

26. The multilayer electronic component of claim 24,
wherein the dielectric composition further includes a second subcomponent including one or more of an oxide or a carbonate of Mg, and
wherein a content of an Mg element included in the second subcomponent is 2.0 mol or less based on 100 mol of the main component.

27. The multilayer electronic component of claim 24,
wherein the dielectric composition further includes a third subcomponent including one or more of an oxide and a carbonate of a rare earth element,
wherein the rare earth element includes one or more of Y, Dy, Ho, Er, Gd, Ce, Nd, Sm, Tb, Tm, La, Gd and Yb, and
wherein a content of the rare earth element included in the third subcomponent is 0.6 mol to 3.0 mol based on 100 mol of the main component.

28. The multilayer electronic component of claim 24,
wherein the dielectric composition further includes a fourth subcomponent including one or more of an oxide and a carbonate of one or more of Ba and Ca, and
wherein a sum of contents of one or more of Ba and Ca included in the fourth subcomponent is 0.19 mol to 4.8 mol based on 100 mol of the main component.

29. The multilayer electronic component of claim 24,
wherein the dielectric composition further includes a fifth subcomponent including one or more of an oxide of Si, and a glass including Si, and
wherein a content of an Si element included in the fifth subcomponent is 0.8 mol to 3.0 mol based on 100 mol of the main component.

30. The multilayer electronic component of claim 24,
wherein the dielectric composition further includes a fourth subcomponent and a fifth subcomponent,
wherein the fourth subcomponent includes one or more of an oxide and a carbonate of one or more of Ba and Ca,
wherein the fifth subcomponent includes one or more of an oxide of Si, a carbonate of Si, and a glass including Si,
wherein a content of an Si element included in the fifth subcomponent is 0.8 mol to 3.0 mol based on 100 mol of the main component, and
wherein, when a sum of contents of one or more of Ba and Ca included in the fourth subcomponent is defined as 4s, and a content of an Si element included in the fifth subcomponent is defined as 5s, the ratio 4s/5s is 0.24 to 1.60.

31. A multilayer electronic component, comprising:
a dielectric composition including a main component, the main component including first and second main components based on BaTiO₃,
wherein the first main component has a core-shell structure including a shell having an atomic ratio of 2*Sn/(Ba+Ti+Sn) or 2*Hf/(Ba+Ti+Hf) to be 1.0% or more and 5.0% or less, and a core having an atomic ratio of 2*Sn/(Ba+Ti+Sn) and 2*Hf/(Ba+Ti+Hf) to be less than 1.0%, and the second main component has an atomic ratio of 2*Sn/(Ba+Ti+Sn) and 2*Hf/(Ba+Ti+Hf) to be less than 1.0%, and
wherein a size of the core of the first main component is 40-200nm.

32. The multilayer electronic component of claim 31,
wherein the dielectric composition further includes a first subcomponent including one or more of an oxide or a carbonate of a variable valence acceptor element,
wherein the variable valence acceptor element includes one or more of Mn, V, Cr, Fe, Ni, Co, Cu and Zn, and
wherein a content of the variable valence acceptor element included in the first subcomponent is 0.2 mol to 1.4 mol based on 100 mol of the main component.

33. The multilayer electronic component of claim 31,
wherein the dielectric composition further includes a second subcomponent including one or more of an oxide or a carbonate of Mg, and
wherein a content of an Mg element included in the second subcomponent is 2.0 mol or less based on 100 mol of the main component.

34. The multilayer electronic component of claim 31,
wherein the dielectric composition further includes a third subcomponent including one or more of an oxide and a carbonate of a rare earth element,
wherein the rare earth element includes one or more of Y, Dy, Ho, Er, Gd, Ce, Nd, Sm, Tb, Tm, La, Gd and Yb, and
wherein a content of the rare earth element included in the third subcomponent is 0.6 mol to 3.0 mol based on 100 mol of the main component.

35. The multilayer electronic component of claim 31,
wherein the dielectric composition further includes a fourth subcomponent including one or more of an oxide and a carbonate of one or more of Ba and Ca, and
wherein a sum of contents of one or more of Ba and Ca included in the fourth subcomponent is 0.19 mol to 4.8 mol based on 100 mol of the main component.

36. The multilayer electronic component of claim 31,
wherein the dielectric composition further includes a fifth subcomponent including one or more of an oxide of Si, and a glass including Si, and
wherein a content of an Si element included in the fifth subcomponent is 0.8 mol to 3.0 mol based on 100 mol of the main component.

37. The multilayer electronic component of claim 31,
wherein the dielectric composition further includes a fourth subcomponent and a fifth subcomponent,
wherein the fourth subcomponent includes one or more of an oxide and a carbonate of one or more of Ba and Ca,
wherein the fifth subcomponent includes one or more of an oxide of Si, a carbonate of Si, and a glass including Si,
wherein a content of an Si element included in the fifth subcomponent is 0.8 mol to 3.0 mol based on 100 mol of the main component, and
wherein, when a sum of contents of one or more of Ba and Ca included in the fourth subcomponent is defined as 4s and a content of an Si element included in the fifth subcomponent is
defined as 5s, the ratio 4s/5s is 0.24 to 1.60.
